(19) United States
(12) Patent Application Publication
(10) Pub. No.: US 2003/0074353 A1
(43) Pub. Date: Apr. 17, 2003

(54) Answer retrieval technique

(76) Inventors: Riza C. Berkan, Annapolis, MD (US); Mark E. Valenti, Knoxville, TN (US)

Correspondence Address: Martin M. Novack, Esq., 1960 Bronson Road, Bldg. 1, Fairfield, CT, 06430, US

(21) Appl. No.: 09/741,749

(22) Filed: Dec. 20, 2000

Related U.S. Application Data
(60) Provisional application No. 60/172,662, filed on Dec. 20, 1999.

(51) Int. Cl. G06F 17/30

(52) U.S. Cl. 707/5; 707/3

(57) ABSTRACT

A method for analyzing a number of candidate answer texts to determine their respective relevance to a query text, includes the following steps: producing, for respective candidate answer texts being analyzed, respective pluralities of component scores that result from respective comparisons with the query text, the comparisons including a measure of word occurrences, word group occurrences, and word sequences occurrences; determining, for respective candidate answer texts being analyzed, a composite relevance score as a function of the component scores; and outputting at least some of the candidate answer texts having the highest composite relevance scores.

### RELATED APPLICATION

This application claims priority from U.S. Provisional Patent Application No. 60/172,662, filed Dec. 20, 1999, and said Provisional Patent Application is incorporated herein by reference.

### FIELD OF THE INVENTION

This invention relates to information retrieval techniques and, more particularly, to information retrieval that can take full advantage of Internet and other huge data bases, while employing economy of resources for retrieving candidate answers and efficiently determining the relevance thereof using natural language processing.

### BACKGROUND OF THE INVENTION

It is commonly known that search engines on the Internet or databases, which contain huge amounts of data, are operated using devices with maximum capacity storage, CPU, and communication available in the market today. The retrieval systems take full advantage of such resources per design and the methods deployed, or will be deployed in the future, utilize elaborate dictionaries, thesarui, semantic ontology (world knowledge), lexicon libraries, etc.

Conventional natural language processing (NLP) techniques are primarily based on grammar analysis and categorization of words in concept frameworks and/or semantic networks. These techniques rely on exhaustive coverage of all the words, their syntactic role, and meaning. Therefore, NLP systems have tended to be expensive and computationally burdensome. Machine translation (MT) and information retrieval (IR), for example, solely depend on the quality of the pre-processed dictionaries, thesauri, lexicon libraries, and ontologies. When implemented appropriately, conventional NLP techniques can be powerful and worth the investment. However, there is a category of text analysis problems, such as the Internet search, in which conventional NLP methods may be overkill in terms of execution time, data volume, and cost.

It is among the objects of the present invention to provide an answer retrieval technique that includes an advantageous form of natural language processing and navigation that overcome difficulties of prior art approaches, and can be conveniently employed with conventional types of wired or wireless equipment.

### SUMMARY OF THE INVENTION

A form of the present invention is a compact answer retrieval technique that includes natural language processing and navigation. The core algorithm of the answer retrieval technique is resource independent. The use of conventional resources is minimized to pertain a strict economy of space and CPU usage so that the AR system can fit on a restricted device like a microprocessor (for example a DSP-C6000), on a hand-held device using the CE, OS/2 or other operating systems, or on a regular PC connected to local area networks and/or the Internet. One of the objectives of the answer retrieval technique of the invention is to make such devices more intelligent and to take over the load of language understanding and navigation. Another objective is to make devices independent of a host provider who designs and limits the searchable domain to its host.

In accordance with a form of the invention there is set forth a method for analyzing a number of candidate answer texts to determine their respective relevance to a query text, comprising following steps producing, for respective candidate answer texts being analyzed, a respective pluralities of component scores that result from respective comparisons with said query text, said comparisons including a measure of word occurrences, word group occurrences, and word sequences occurrences; determining, for respective candidate answer texts being analyzed, a composite relevance score as a function of said component scores; and outputting at least some of said candidate answer texts having the highest composite relevance scores. It will be understood throughout, that synonyms and other equivalents are assumed to be permitted for any of the comparison processing.

Further features and advantages of the invention will become more readily apparent from the following detailed description when taken in conjunction with the accompanying drawings.

### BRIEF DESCRIPTION OF THE DRAWINGS

FIG. 1 is a block diagram, partially in schematic form, of an example of a type of equipment in which an embodiment of the invention can be employed.

FIG. 2 is a general flow diagram illustrating elements used in an embodiment of the invention.

FIG. 3 is a general outline and flow diagram in accordance with an embodiment of the invention of an answer retrieval technique.

FIG. 4 shows an example of a prime question, a related context (explanation of the question), and a candidate text to be analyzed.

FIG. 5 is a flow diagram which illustrates the process of determining occurrences.

FIG. 6 illustrates examples of partial sequences.

FIG. 7 is a flow diagram illustrating a routine for partial sequence measurement.

FIGS. 8A through 8D are graphs illustrating non-linearity profiles that depend on a non-linearity selector, K.

FIG. 9 illustrates the results on the relevance function for different values of K.

FIG. 10 is a table showing measurements that can be utilized in evaluating the relevance of candidate answer texts in accordance with an embodiment of the invention.

FIG. 11 illustrates multistage retrieval.

FIG. 12 illustrates the loop logic for a navigation and processing operation in accordance with an embodiment of the invention.

FIG. 13 illustrates an embodiment of the overall navigation process that can be utilized in conjunction with the FIG. 12 loop logic.

### DETAILED DESCRIPTION

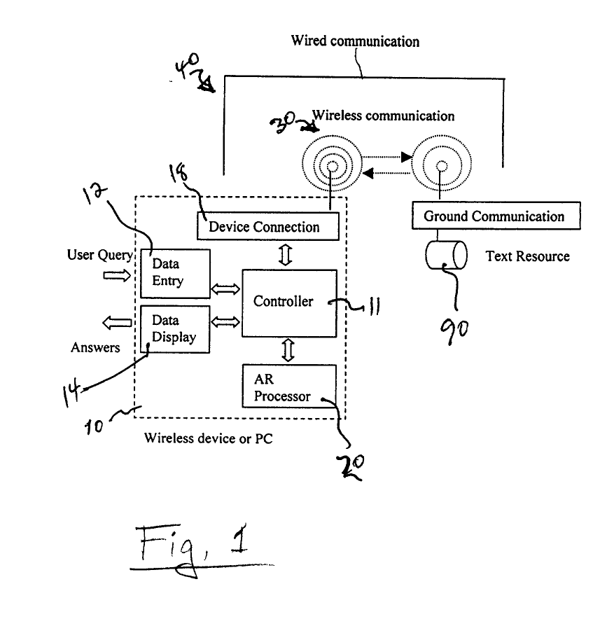

FIG. 1 shows an example of a type of equipment in which an embodiment of the invention can be employed. An intelligent wireless device or PC is represented in the dashed enclosure 10 and typically includes a processor or controller 11 with conventional associated clock/timing and memory functions (not separately shown). In the example of FIG. 1, a user 100 implements data entry (including queries) via device 12 and has available display 14 for displaying answers and other data and communications. Also coupled with controller 11 is device connection 18 for coupling, via either wireless communication subsystem 30, or wired communication subsystem 40, with, in this example, text resources 90 which may comprise Internet and/or other data base resources, including available navigation subsystems. The answer retrieval (AR) technique hereof can be implemented by suitable programming of the processor/controller using the AR processes described herein, and initially represented by the block 20. The wireless device can be a cell-phone, PDA, GPS, or any other electronic device like VCRs, vending machines, home appliances, home control units, automobile control units, etc. The processor(s) inside the device can vary in accordance with the application. At least the minimum space and memory requirements will be provided for the AR functionality. Data entry can be a keyboard, keypad, a hand-writing recognition platform, or voice recognition (speech-to-text) platform. Data display can typically be by visible screen that can preferably display a minimum of 50 words.

A form of the invention utilizes fuzzy syntactic sequence (FUSS) technology based on the application of possibility theory to content detection to answer questions from a large knowledge source like Internet, Intranet, Extranet or from any other computerized text system. Input to a FUSS system is a question(s) typed or otherwise presented in natural language and the knowledge (text) received from an external knowledge source. Output from a FUSS system are paragraphs containing answers to the given question with scores indicating the relevance of answers for the given question.

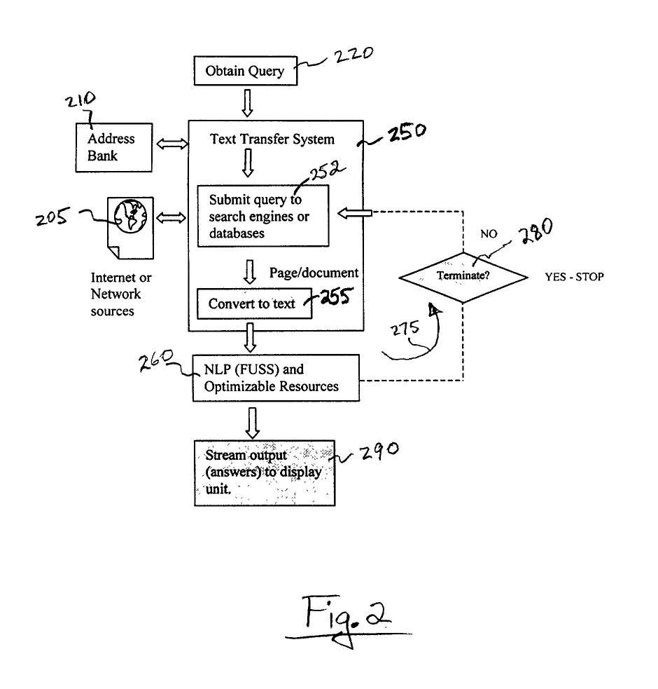

FIG. 2 is a general flow diagram illustrating elements used in an embodiment hereof. The Internet or other knowledge sources are represented at 205, and an address bank 210 contains URLs to search engines or database access routes. These communicate with text transfer system 250. A Query is entered (block 220) and submitted to search engines or databases (252) and information is converted to suitable text format (255). The block 260 represents the natural language processing (NLP) using fuzzy syntactic sequence (FUSS) of a form of the invention, and use of optimizable resources. After initial processing, further searching and navigation can be implemented (loop 275) and the process continued until termination (decision block 280). During the process, output answers deemed relevant, together with relevance scores, are streamed (block 290) to the display unit.

FIG. 3 is a general outline and flow diagram in accordance with an embodiment of the invention, of an answer retrieval technique using natural language processing and optimizable resources. The blocks containing an asterisk (*) are optimizable uploadable resources. The numbered blocks of the diagram are summarized as follows:

1—Query Entry: Normally supplied by the user, it can be a question or a command, one or more sentences separated by periods or question marks.

2—Query filtering is a process where some of the words, characters, word groups, or character groups are removed. In the removal process, a pool of exact phrases is used that protect the elimination of certain important signatures like “in the red” or “go out of business”. Stop words pool include meaningless words or characters like “a” and “the” etc.

3—Query enrichment is a process to expand the body of the query. “Did XYZ Company declare bankruptcy” can be expanded to also include “Did XYZ Company go out of business?” Daughter queries are build and categorized by an external process, such as an automated ontological semantics system, and the accurate expansion can be made by a category detection system. Query enrichment can also include question type analysis. For example, if the question is “Why” type, then “reason” can be inserted into the body of the expanded query. This step is not a requirement, but is an enhancement step.

4—Text entry and decomposition are a process where a candidate document is converted into plain text (from a PDF, HTML, or Word format), and broken into paragraphs. Paragraph detection can be done syntactically, or by a sliding window comprised of a limited number of words. Text transfer denotes a process in which the candidate document is acquired from the Internet, database, local network, multi-media, or hard disk.

5—Text filtering is a similar process to query filtering. Stop word and exact phrase pools are used.

6—FUSS block denotes a process, in accordance with a feature hereof, in which the query and text are analyzed simultaneously to produce a relevance score. This process is mainly language independent and is based on symbol manipulation and orientation analysis. Morphology list provides language dependent suffex list for word ending manipulations. Output of the system is a score, which can be expressed in percentage, that quantifies the possibility of encountering an answer to the query in each paragraph processed.

7—Linguistic wrappers is an optical quality assurance step to make sure certain modes of language are recognized. This may include dates, tenses, etc. Wrappers are developed by heuristic rules.

The present invention employs techniques including, inter alia, possibility theory. As is well documented, a basic axiom of possibility theory is that if an event is probable it is also possible, but if an event is possible it may not necessarily be probable. This suggests that probability (or Bayesian probability) is one of the components of possibility theory. A possibility distribution means one or more of the following: probability, resemblance to an ideal sample, capability to occur. While a probability distribution requires sampling or estimation, a possibility distribution can be built using some other additional measures such as theoretical knowledge, heuristics, and common sense reasoning. In the present invention, possibilistic criteria are employed in determining relevance ranking for context match.

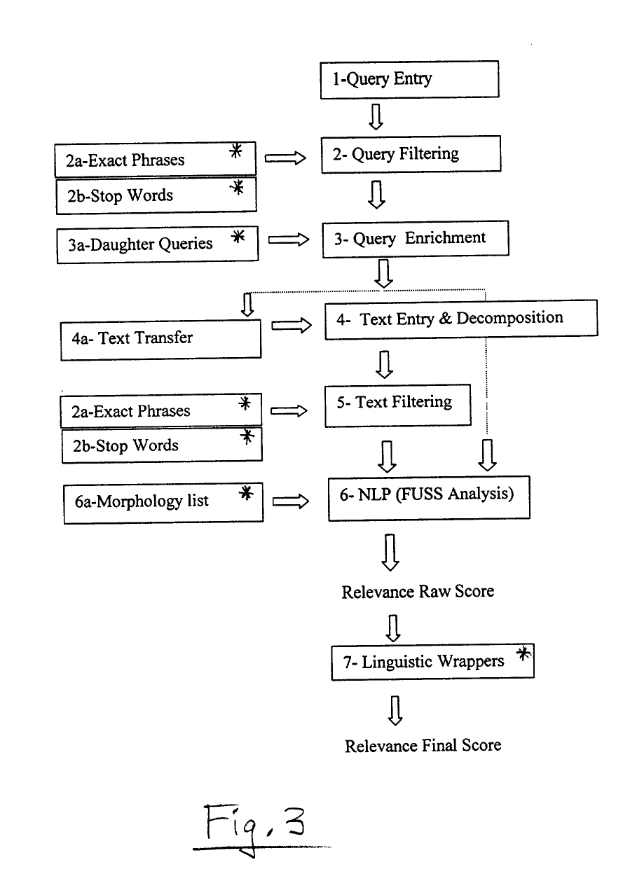

In a form of the present invention there are available three different knowledge domains. Consider the presentation in FIG. 4, where each box represents a word that does not exist in a filter database. The prime question (dark boxes) and related context (i.e., explanation of the question—shown as open boxes) are the user's entries. They are two different domains as they originate from different semantic processes. The third domain is the test context (that is, the candidate answer text to be analyzed—shown as gray or dotted boxes) that is acquired from an uncontrollable, dynamic source such as the html files on the Internet.

The following describes measurements and factors relating to their importance, it being understood that not every measurement is necessarily used in the preferred technique.

Paragraph Raw Score (PRS)

Paragraph raw score is the occurrence of prime-question-words, explanation words, or their synonyms in the test domain (matching dark boxes or light boxes to gray boxes in FIG. 4). This is generally only useful for the exclusion of paragraphs. The possibility of containing an answer to the question is zero in a text that has a zero PRS.

Paragraph Raw Score Density (PRSD)

The Paragraph Raw Score Density (PRSD) is the PRS divided by the number of words in the text. This is not very informative measurement and is not utilized in the present embodiment. However, the PRSD may indicate the density of useful information in a text related to the answer.

Paragraph Word Count (PWC)

The Paragraph Word Count (PWC) spectrum is the occurrence of every word (dark boxes and light boxes or their synonyms) at least once in the text (no repetitions). Prime question words are more important than the words in the explanation. The relative importance can be realized by applying appropriate weights. Accordingly, in an embodiment hereof PWC is computed by

$$P W C = \frac{{W}_{1} {n}_{1} + {W}_{2} {n}_{2}}{{W}_{1} {N}_{1} + {W}_{2} {N}_{2}} \qquad ( 1 )$$

where n and N represent the matching words encountered in the text and the total number of words defined by the user, respectively. Subscripts 1 and 2 correspond to prime question and explanation domain words whereas Ws represent their importance weights, respectively. Applicant has noted that there is an approximate critical PWC score below which a candidate answer text cannot possibly contain a relevant answer. Accordingly, a threshold on PWC can be used to disqualify texts that do not contain threshold on PWC can be used to disqualify texts that do not contain enough number of significant words related to the context. This threshold is adjustable such that higher the threshold, the more strict the answer search is. sufficient number of significant words related to the context. This threshold is adjustable such that higher the threshold, the more strict the answer search is.

Prime Word Occurrence Within a Sentence Enclosure (W1D)

This measurement consists of counting prime words (dark boxes in FIG. 4 or their synonyms) encountered in any single sentence in the text divided by the number of words in the prime question.

$$W1D = \frac{{n}_{1}}{{N}_{1}} \qquad ( 2 )$$

Applicant has noted that the possibility of a candidate answer text containing an answer to the query is reasonably high in a text where at least one of the sentences contains a high number of prime words. Although this criterion is, in part, word-based, it is also a measurement of sequences, due to the sentence enclosure. If the number of prime question words is small (i.e., two or three) the effect will be less pronounced. Therefore, the effect of the W1D measurement to the final relevance score is a non-linear function, as described elsewhere herein.

In at least most of the measurements hereof, it is desirable to include variations during a matching process. The definition of single occurrence is to find a symbol in the test object (candidate answer text) that exactly matches to one in the target object (the querytext). In cases when there are known variations of the symbol, the occurrence is decided by trying all known variations during the matching process. In the analysis of text in English for example, variations require morphological analysis to accomplish accurate match. FIG. 5 illustrates the process. The test symbol (block 510) is compared (decision block 540) to the target symbol (block 520). If there is a match, the occurrence is confirmed (block 550). If not, a variation is applied to the test symbol (block 560), and the loop 575 continues as the variations are tried, until either a match occurs or, after all have been unsuccessfully tried (decision block 565), an occurrence is not confirmed (block 580). In the described process, the application of the variation to the test symbol can be, for example, adding a suffix or removing a suffix at the word level (suffix coming from an external list) in western languages like English, German, Italian, French, or Spanish. It can also require replacement of the entire symbol (or word) with its known equivalent (replacements coming from an external list). Regarding group occurrence with variation, the process is similar. However, variations are applied to all the symbols one at a time during each comparison in this case. All permutations are tried. For 2 symbols for example, the permutations yield 4 comparisons (A and B, modified A and B, A and modified B, modified A and modified B). Occurrence of a group of symbols with order change is similar to the occurrence of a group symbol. However, variations are applied to all the symbols one at a time during each comparison in addition to changing the order of the symbols. All permutations are tried. For 2 symbols for example, the permutations yield 8 comparisons (A and B, modified A and B, A and modified B, modified A and modified B, B and A, modified B and A, B and modified A, modified B and modified A). No extra symbol is allowed in this operation.

A measurement to obtain a spectrum of single occurrences requires that there are more than one target signal (query word). The spectrum can be calculated by

$${S}_{N} = f ( {x}_{j} ) {x}_{j} = \{ 0 , 1 \}$$

$${f}_{1} ( {x}_{j} ) = \frac{{\sum }_{j = 1 , M} {x}_{j}}{M}$$

$${f}_{2} ( {x}_{j} ) = \frac{1}{1 + {ⅇ}^{\frac{{\sum }_{j = 1 , M} {x}_{j}}{M}}}$$

where x is the single occurrence of any target symbol in the body (paragraph) of the test object (text). If the target symbol xⱼ occurs in the body of the test object, the occurrence is 1, otherwise is 0. Any one of the two f functions given above can be used as a nonlinear separator that can magnify S above 0.5 or inhibit S below 0.5 when needed. M is the total number of symbols in the target object. N denotes which test object is used in the process.

### EXAMPLE

Target Object contains A, B, C, Z

Test Object contains A, B, C, D, E

M=4

$${f}_{1} ( {x}_{j} ) = \frac{{\sum }_{j = 1 , M} {x}_{j}}{M} = \frac{1 ( A matches A ) + 1 ( B matches B ) + 1 ( C matches C )}{4} = \frac{3}{4} = 0.75$$

Creating this measurement can make use of an auxiliary target object (enriched query; e.g. with the explanation text). This is not a requirement. Auxiliary target object is known priori to have association to the main target object and can be used as a signature pool. In this case spectrum is computed by

$${S}_{N} = \frac{{W}_{1} f ( {x}_{j} ) + {W}_{2} f ( {y}_{j} )}{{W}_{1} {M}_{1} + {W}_{2} {M}_{2}} 0 \leq {x}_{j} \leq 1$$

where W₁ and W₂ are weights assigned by the designer describing the importance of the auxiliary target with respect to the main target object. This is a form of the equation above for PWC.

A further measurement is a spectrum of group occurrences. This measurement is similar to the single occurrence. In this case however, everything is now replaced by the occurrence of a group of symbols. On the example above, A is now a group of symbols A={x y z} and M denotes the number of groups. The group occurrence is denoted by S*. The group occurrence with order change is denoted by S**.

Consider next the spectrum in the signature domain. This measurement is identical to f, f*, f** except that the domain is now only the signature (sentence) not the whole body (paragraph). However, since there could be several signatures in a body (several sentences in a paragraph), each signature is evaluated separately. The maximum score for the body is:

s=max(s₁, s₂, . . . , sₖ)

s*=max(s₁* s₂*, . . . , sₖ*)

s**=max(s₁**,s₂**, . . . , sₖ**)

and the average score for the body is:

$$\overline{s} = \frac{{\sum }_{k} {s}_{k}}{k}$$

$${\overline{s}}^{*} = \frac{{\sum }_{k} {s}_{k}^{*}}{k}$$

$${\overline{s}}^{**} = \frac{{\sum }_{k} {s}_{k}^{**}}{k}$$

where k is the number of signatures in the body.

Sequence Measurements

A sequence is defined as a collection of symbols (words) that form groups (phrases) and signatures (sentences). A full sequence is the entire signature whereas a partial sequence is the groups it contains. Knowledge presentation via natural language embodies a finite (and computable) number of signature sequences, complete or partial, such that their occurrences in a text is a good indicator for a context match. Consider the following example.

Target Object (query):

If you look for 37 genes on a chromosome, as the researchers did, and find that one is more common in smarter kids, does this mean a pure chance rather than a causal link between the gene and intelligence?

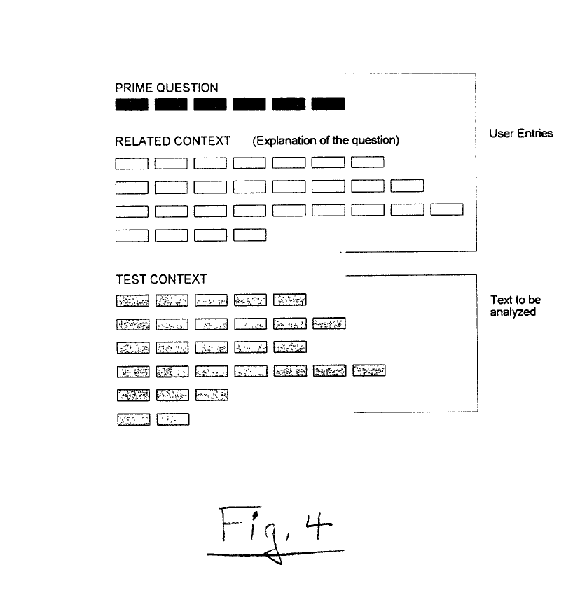

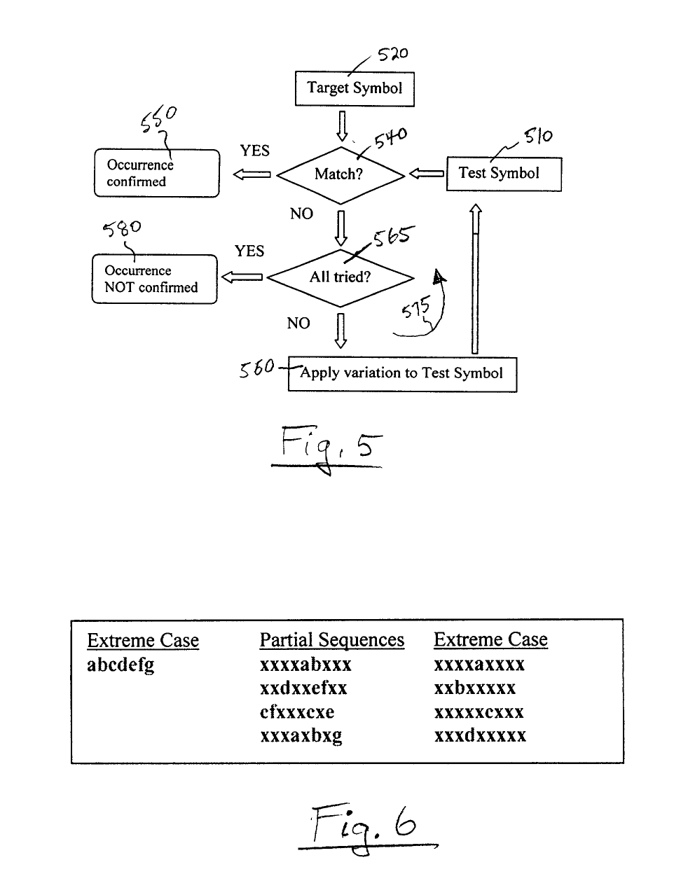

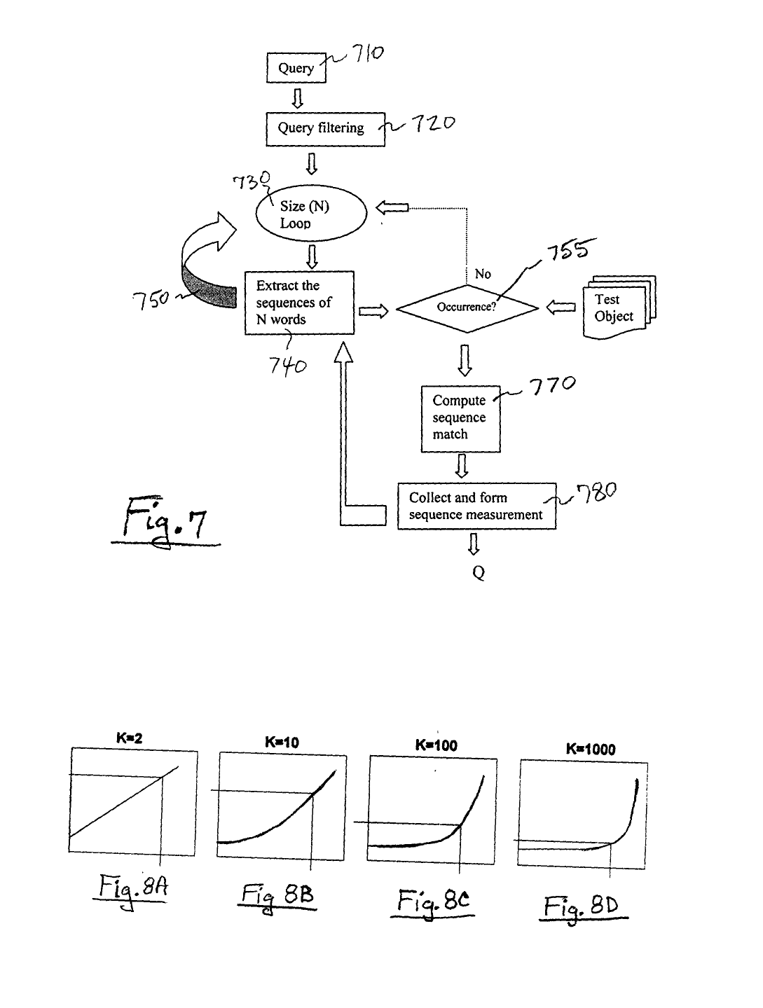

There are 8.68×10³⁶ possible sequences using 33 words above one of which only conveys the exact meaning. Therefore, searching for such an exact sequence in a text is pointless. FIG. 6 illustrates symbolically the two extreme cases, and in between one of many possible intermediate cases where partial sequences would be encountered. The assumption states that the possibility of finding an answer in a text similar to that in the middle, of FIG. 6 is higher than that on the right of FIG. 6 because of partial sequences that encapsulate phrases and important relationships. Finding the one on the left in FIG. 6 is statistically impossible. Some of such partial sequences are marked in the following example.

If you look for 37 genes on a chromosome, as the researchers did, and find that one is more common in smarter kids, does this mean a pure chance rather than a causal link between the gene and intelligence. The underlined sequences, and others not illustrated for simplicity, can occur in a text in slightly different order or with synonyms/extra words. For example, lets take one of the sequences:

Link between the gene and intelligence

| GOOD SEQUENCES | BAD SEQUENCES |
|---|---|
| Relationship between intelligence | Link between researchers and |
| and genes | smart kids |
| Effect of genetics on intelligence | Causal link between genes and |
| | chromosome |
| Do genes determine smartness? | Researchers did find a gene by |
| | pure chance |
| Correlation between smarts and genes | Common link between researchers |
| | and kids |

The challenge is to formulate a method to distinguish good sequences (related) from bad sequences (unrelated). One of the characteristics of the bad sequences is that they are made up of words or word groups that come from different (i.e., coarse) locations of the original sequence (prime question). Therefore, a sequence analysis can detect coarseness. But, in accordance with a feature hereof, the analysis automatically resolves content deviation by the multitude of partial sequences found in a related context versus the absence of them in an unrelated context.

For example, in the question “What is the most expensive French wine?” the bad partial sequences such as expensive French (cars) or most wine (dealers) imply different contexts. Thus, more partial sequences must be found in the same paragraph to justify the context similarity. In the ongoing example, if the text is about French cars then the sequences of expensive French wine will not occur. Accordingly, the absence of other sequences will signal a deviation from the original context.

Sequence Length and Order (W1S)

To distinguish between the good partial sequences and bad ones, the following symbolic sequence analysis is performed.

$$F ( x ) = \frac{1}{1 + 19 {ⅇ}^{( - A x )}} \\ W1S = F ( o m ) \cdot F ( d l ) \\ d l = \frac{min [ {L}_{t} , {L}_{p} ]}{max [ {L}_{t} , {L}_{p} ]} \\ o m = \frac{1}{m} {\sum }_{m} {r}^{1 - \frac{\vert {D}_{t} \vert}{{D}_{t}}} ( \frac{min [ \vert {D}_{t , m} \vert , {D}_{p , m} ]}{max [ \vert {D}_{t , m} \vert , {D}_{p , m} ]} ) \qquad ( 3 )$$

Above, dl and om are length and order match indices. L and D denote length and word-distance, respectively. Subscripts t, p, m denote test object, prime question, and number of couples, respectively. An example to order match is provided below. The constants used above are A=10, r=0.866 (i.e., r²⁼0.75). A determines the profile of nonlinearity whereas r is the inverse coefficient. The constant 19 was empirically determined.

As an example, consider three sequences of equal length as shown below. The first sequence is a symbolic representation of the prime question with A, B, C tracked words. Here Lₜ=Lₚ, dl=1 and F(dl) is approximately equal to 1. The example below illustrates how om computation differentiates between the relatively good order (sequence-2) and bad order (sequence-3).

| | | |
|---|---|---|
| 1- A X B C X X X | Dac = 3, Dab = 2, Dbc = 1 | ; query. |
| 2- A X X X B C X | Dac = 5, Dab = 4, Dbc = 1 | ; test sequence |
| 3- X X B X X C A | Dac = −1, Dab = −4, Dbc = 3 | ; test sequence |

Above, the calculation of a word distance (D) is based on counting the spaces between the two positions of the words under investigation. For example, D_{ac} in the first sequence is 3 illustrating the 3 spaces between the words A and C. The distance can be negative if the order of appearance with respect to the prime question is reversed. D_{ac}=−1 in sequence-3 is, therefore, a negative number. Since there are 3 words tracked (i.e., AB, AC, BC) m is 3. As shown below 1-sign(Dₚₘ) is zero for positive D and 2 for negative D that determines r to be either 1 or 0.75.

$$o {m}_{1 , 2} = \frac{1}{3} ( {( 0.866 )}^{0} \frac{3}{5} + {( 0.866 )}^{0} \frac{2}{4} + {( 0.866 )}^{0} \frac{1}{1} ) ≅ 0.7$$

$$o {m}_{1 , 3} = \frac{1}{3} ( {( 0.866 )}^{2} \frac{1}{3} + {( 0.866 )}^{2} \frac{2}{4} + {( 0.866 )}^{0} \frac{1}{3} ) ≅ 0.3$$

The measurements above indicate that the ordering comparison between the 3^{rd} sequence and the 1^{st} sequence is worse than that between the 2^{nd} sequence and the 1^{st} sequence. Considering the previous example, the sequence “link between genes and chromosome” will be bad because of the huge distance between the words “genes” and “chromosome” encountered in the prime question. The performance of this approach depends on the coarseness assumption which is true for most cases when the query is reasonably long or is enriched via expansion.

Coverage of Partial Sequences (W1P)

The number of known partial sequences encountered in a text is a very valuable information. A text that contains a large number of known partial sequences will possibly contain the answer context.

The measurement is constructed by counting the occurrence of partial sequences in a sentence at least once in a given text. For example:

| | |
|---|---|
| A B C D | Full sequence |
| A B C | 3/4 sequence |
| A C D | 3/4 sequence |
| B C D | 3/4 sequence |
| AB | 1/2 sequence |
| AC | 1/2 sequence |
| AD | 1/2 sequence |
| BC | 1/2 sequence |
| BD | 1/2 sequence |
| CD | 1/2 sequence |

If N is 4, as illustrated above by A, B, C, and D, the total number of sequences to be searched is 10. For N=10, the search combinations exceed 1000. However, the search can be performed per sentence instead of per combination that reduces the computation time to almost insignificant levels.

Example: Consider the full sequence ” What is the most expensive French wine?” After filtering, the A, B, C, D sequence becomes

| | |
|---|---|
| Most, Expensive, French, Wine | Full sequence |
| Most, Expensive, French | 3/4 sequence |
| Most, French, Wine | 3/4 sequence |
| Expensive, French, Wine | 3/4 sequence |
| Most, Expensive | 2/4 sequence |
| Most, French | 2/4 sequence |
| Most, Wine | 2/4 sequence |
| Expensive, French | 2/4 sequence |
| Expensive, Wine | 2/4 sequence |
| French, Wine | 2/4 sequence |

Consider the following text:

French wine is known to be the best. (2/4=0.5)

An expensive French wine can cost more than a car. (¾=0.75)

In this text, the total score is 0.5+0.75=1.5 because two partial sequences are found. Recall that W1D will be 0.75 in this text. Thus, W1P indicates the occurrence of some other sequences beyond the maximum indicated by W1D.

Minimum effective W1P level is important. Given A, B, C, D, the question is how two texts with different partial sequences must compare. For example, if the first text has two partial sequences with 0.5 (0.5+0.5=1.0) and the second text has one partial sequence with 0.75, which one should score higher? The following importance distribution chart illustrates this situation.

Complete scores:

ABC=AB, AC, BC=3×0.67=2.0

ABCD=AB, AC, AD, BC, BD, CD=6×0.5=3.0

ABCD=ABC, ABD, BCD=3×0.75=2.25

The ABC (i.e., the sequence with 3 entries) is the minimum condition for W1P measurement. Thus, the minimum effective W1P is determined for ABC by the following assumption: .At the minimum case where only three words form the full sequence, (2×0.67=1.34) is possibly the best W1P score below which partial sequences will not imply a context match.

In “expensive French wine”, this assumption states that both “expensive wine” and “French wine” sequences must be found as a minimum criteria to activate W1P measurement. If only one occurs, then W1P measurement is not informative.

When this limit is applied to ABCD (i.e., sequence with 4 words), then the minimum criteria are:

ABC,ABD(2×0.75=1.5) or

AB,AC,AD(3×0.5=1.5) or

ABC,AB,AC(0.75+2×0.5=1.75)

Above, the selection of the letters was made arbitrarily just to make a point.

Normalization of W1P is performed after the minimum threshold test (i.e., W1P=1.34). Once this minimum is satisfied, then the paragraph W1P is divided to the maximum number of good sentences (i.e., sentences with a partial sequence). For example:

If ABCD full sequence

| Paragraph-1 | Paragraph-2 |
|---|---|
| ABCD and AB found (1 + 0.5 = 1.5) | AB, AC, BC are found |
| | (3 × 0.5 = 1.5) |
| 2 sentences with sequence | 3 sentences with sequence |
| Paragraph-1 score | Paragraph-2 score |
| 1.5/3 = 0.5 | 1.5/3 = 0.5 |

FIG. 7 is a flow diagram illustrating a routine for partial sequence measurement. In input query (block 710) is filtered (block 720), and for a size N (block 730) sequences of N words are extracted (block 740 and loop 750). Upon an occurrence (decision block 755), a sequence match is computed (block 770), and these are collected for formation of the sequence measurement (block 780), designated Q. An example of decomposition into partial sequences is as follows:

The method set forth in this embodiment creates sequences from the target object (query) and searches these sequences in the test object body (paragraph). Once the occurrence is confirmed as described above, then the sequence measurement is formed based on the technique described, for each sequence. The final sequence measure Q is the collection of all individual scores as follows:

$${Q}_{m} = max {\{ {ψ}_{j} ( x ) \}}_{j = 1 , L}$$

$${Q}_{T} = {\sum }_{j = 1 , L} {ψ}_{j} ( x )$$

$$\overline{Q} = \frac{{\sum }_{j = 1 , L} {ψ}_{j} ( x )}{L}$$

Here Qₘ, Q_{T} and \overline{Q} denote the maximum, total, and average values, respectively where L is the number of sequences generated.

Paragraph Scoring

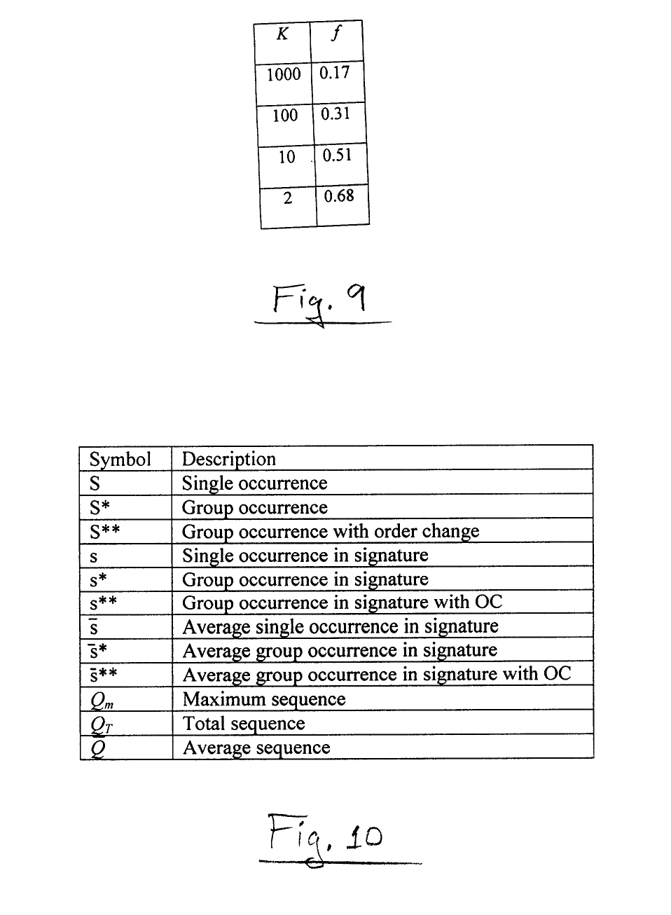

In an embodiment hereof, paragraphs (also called blocks) are scored using the following expression:

$$R = \frac{\begin{matrix}{a}_{1} ( \frac{{K}_{1}^{W1P} - 1}{{K}_{1} - 1} ) + {a}_{2} ( \frac{{K}_{2}^{W1D} - 1}{{K}_{2} - 1} ) + \\ {a}_{3} ( \frac{{K}_{3}^{P W C} - 1}{{K}_{3} - 1} ) + {a}_{4} ( \frac{{K}_{4}^{W1S} - 1}{{K}_{4} - 1} )\end{matrix}}{{a}_{1} + {a}_{2} + {a}_{3} + {a}_{4}}$$

where a is a relative importance factor (all set to 0.25 for an exemplary embodiment) and Ks are nonlinear profiles. The K profiles (i.e., f=k(W1P) for example) are approximately set forth in FIG. 8A-8D. The selection of K, therefore, determines tolerance to medium measurements. If K=1000 medium measurements will not be tolerated whereas if K=2 medium measurements will be effective. If the measurement is 0.75, the following result will be as shown in FIG. 9. In an example of an embodiment hereof the following K values can be utilized:.

For 0.75

If PWC is 0.75 its effect should be reflected linearly (0.68, K=2).

If W1D is 0.75 its effect should be diminished to 0.31 (K=100)

If W1P is 0.75 its effect should be diminished to 0.51 (K=10)

If W1S is 0.75 its effect should be diminished to 0.31 (K=100)

Above, PWC is the word coverage in a paragraph that has a linear effect to scoring. Basically, the more words there are, the better the results must be. W1D is the maximum number of occurrence of words in any sentence. It will imply context match when most of the words are found. W1D=0.75, which means 3 out of 4 words are encountered in a sentence, will be diminished to 0.31 indicating the fact that there is a small possibility of context match. For example, the occurrence of 3 words in “most expensive French wine” such as “most expensive wine” or “expensive French wine” implies a context match whereas “most expensive French (cars)” is totally misleading. The same argument applies to W1S, which is a sequence order analysis. If the order of words does not match (coarseness), then there is a chance for context deviation. “When French sailors drink wine, they hire the most expensive prostitutes” include all 4 words but the context is totally different. Therefore, W1S must only dominate when W1D is high, preferably equal to 1. W1P, which is the count of partial sequences, is not as linear as PWC but more linear than both W1D and W1S. When W1D is medium (i.e., 0.5-0.75) W1P can serve as a rescue mechanism for context match. For example, in two sentences such as “French wine is the best. The most expensive bottle is..” both W1D and W1S will be insignificant. However, W1P will score higher. Thus, when W1D and W1S are low and W1P high then a possible context match exists. These adjustments are, in some sense, based on the 2-out-of-3 rule with the assumption that the suggested distributions yield good results on the average. The technique permits adjustment of these parameters.

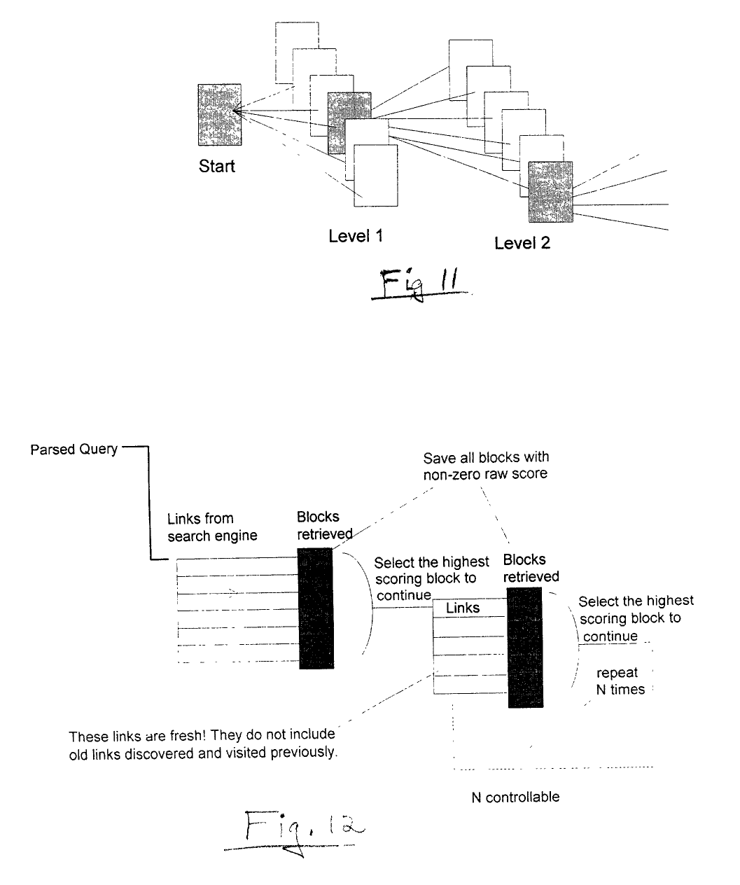

In accordance with a further embodiment hereof, the Table of FIG. 10 shows measurements that can be utilized in evaluating the relevance of candidate answer texts. In accordance with a form of this embodiment, the following expression is used to score the relevance of a candidate answer text.

$$R = \frac{\begin{matrix}{a}_{1} ( \frac{{K}_{1}^{{Q}_{T}} - 1}{{K}_{1} - 1} ) + {a}_{2} ( \frac{{K}_{2}^{s} - 1}{{K}_{2} - 1} ) + \\ {a}_{3} ( \frac{{K}_{3}^{S} - 1}{{K}_{3} - 1} ) + {a}_{4} ( \frac{{K}_{4}^{{Q}_{m}} - 1}{{K}_{4} - 1} )\end{matrix}}{{a}_{1} + {a}_{2} + {a}_{3} + {a}_{4}}$$

In this example, as above, diverse measurement of the candidate answer text includes consideration of a word occurrence score (S) and a word sequence score (Qₘ—maximum sequence), as well as in this example, a single occurrence in signature score (s) and a further sequence score (Q_{T}—total sequence). It can be noted that the Q measurements are also partially based on S measurements.

The measurements described above can all be augmented based on the availability of externally provided resources (libraries, thesauri, or concept lexicons developed by ontological semantics). The target object symbols or symbol groups are replaced by equivalence symbols or symbol groups using OR Boolean logic. For example, consider target object

ABC

Given A=X, then the measurement string becomes

{A or X} B C

Given A B =X Y, then the measurement string becomes

{(A B) or (X Y)} B C

All occurrence measurements and their propagation to sequence measurements can be augmented in this manner.

Measurement augmentation by inserting resource symbols are subject to variation (morphology analysis). As depicted in FIG. 5, variations can be handled within the OR Boolean operation.

Expanded string {A or X} B C becomes

{A or A⁺ or A⁻ or X or X⁺ or X⁻} B C

Note that, this operation is already handled by the occurrence mechanism in FIG. 5, and is only repeated here for clarity.

Another form of measurement augmentation is called daughter target objects. A symbol group A B C can be expanded with another group either in the same signature or with a new one

Given A B C

Duaghter B F G

New Target A B C E F G

Or New Targets

A B C

E F G

### Example

Did XYZ Co. declare bankruptcy? (query)

XYZ Co. {(declared bankruptcy) or (in the red)} (query expanded) or

Is XYZ Co. in the red? (daughter query)

Evaluation Enhancement by Rule-Based Wrappers

The overall score of the FUSS algorithm can be improved by a last stage operation where a rule-based (IF-THEN) evaluation takes place. In application to text analysis, these rules comes from domain specific knowledge.

### Example

Why did YXZ Co. declare bankruptcy?

IF (Query starts with {Why}) AND (best sentence include {Reason})

THEN increase the score by X

Along the same lines, the rule-based evaluation can be fuzzy rule-based evaluation. In this case, extra measurements may be required.

### Example

IF (the number of Capitalized words in the sentence is HIGH)

THEN ({acquisition} syntax is UNCERTAIN)

THEN (Launch {by} syntax analysis)

Various natural language processing enhancements can be applied in conjunction with the disclosed techniques, some of which have already been treated.

Vocabulary Expansion

The word space created by the prime question is often too restrictive to find related contexts that are defined using similar words or synonyms. There are two solutions employed in this method. First, the explanation step will serve to collect words that are similar, or synonyms. (It is assumed that the user's explanation will contain useful words that can be used as synonyms, and useful sequences that can be used as additional measurements. Second, a concept tree can be employed to create a new word space.

Partial Versus Whole Words

Possible word endings are treated using an ending list and a computerized removal mechanism. The word “chew” is the same as “chewing”, “chewed”, “chews”, etc. Irregular forms such as “go-went-gone” are also treated.

Filters

As previously indicated, there are several words that are insignificant context indicators such as “the”. A filter list is used to remove insignificant words in the analysis.

Word Insertions

Simple extra word insertions are employed in the prime question level. The following list shows examples of the inserted words.

Why—Reason

When—Time

Where—Place, location

Who—Bibliography, personality, character

How many—The number of

How much—Quantity

These insertions can amplify the context in the prime question during navigation.

Sequence Concept Tree (SCT)

In the course of sequence analysis, certain sequences are replaced based on the entries in the SCT. For example, the sequence best-race-car can be replaced by best-race-automobile. The sequences are preserved when replaced, and are not approximated or switched in order. This improves the content detection capability of the overall operation.

Multistage Retrieval

In cases where a document pool is too large to evaluate every document, a multi-stage retrieval can be employed provided documents contain references (links) to each other based on relevance criteria determined by human authors. This is depicted in FIG. 11.

Assume that the test object is shown at the Start level above. The analysis hereof (i.e. the fuzzy syntactic sequence analysis [FUSS] of the preferred embodiment) of all Level-1 documents, which were referenced at the Start level, yields a highest score. Then its references are analyzed for the same starting query. The highest scoring test object at Level-2, provided the score is higher than that of Level-1, will further trigger higher Level evaluations. In case the higher Level scores are lower than the that of the previous Level, then the references of the second best score in the previous Level are followed. This process ends when (1) a user specified time or space limit is reached, or (2) highest scoring object is found in the entire reference network and there is no where else to go.

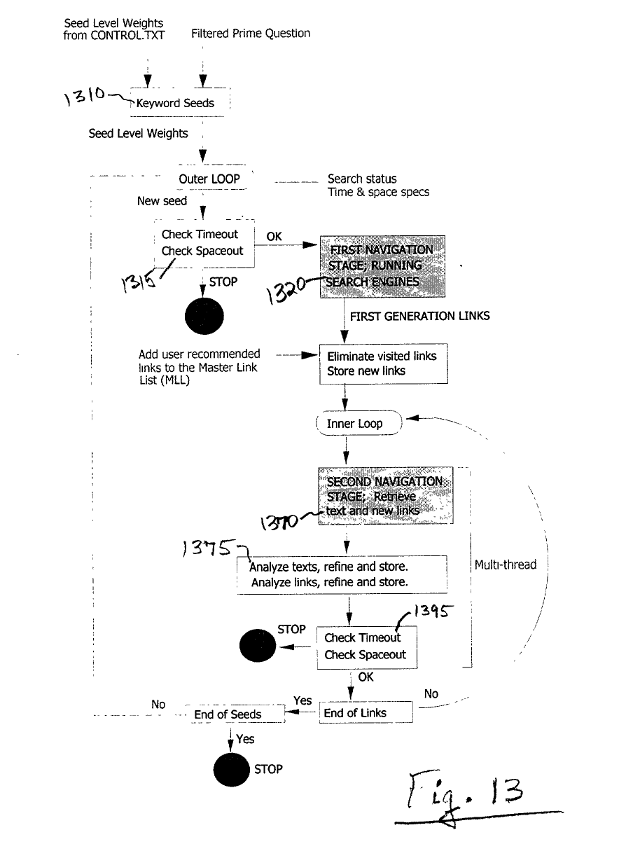

FIG. 12 shows the same process for web navigation using the results of the conventional search engines. Here, a parsed query is sent to a search engine, and the resulted link list is evaluated by analyzing every web page using the FUSS algorithm. Then the best link is determined for the next move.

The FUSS technique, in accordance with an embodiment hereof, because it is fast and mostly resource independent, makes this process feasible (on-the-fly) in application to devices (or PCs) that do not have enough storage space to contain an indexed map of the entire Internet. Utilization of conventional search engines and navigating through the results by automated page evaluation are among the benefits for the user of the technique hereof.

In embodiments hereof, the Internet prime source of knowledge. Thus, navigation on the Internet by means of manipulating known search engines is employed. The automatic use of search engines is based on the following navigation logic. It is generally assumed that full length search strings using quotes (looking for the exact phrase) will return links and URLs that will contain the context with higher possibility than if partial strings or keywords were used. Accordingly, the search starts at the top seed (string) level with the composite prime question. At the next levels, the prime question is broken into increasingly smaller segments as new search strings. An example of the navigation logic, information retrieval, and answer formation are summarized as follows.

1. Submit the entire prime question as the search string to all major search engines.

2. Follow the links several levels below by selecting the best route (by PWC measure).

3. Download all the selected URLs without graphics or sound.

4. Proceed with submitting smaller segments of the prime question as the new search strings to all major search engines and perform the steps 2 and 3 without revisiting already visited sites.

5. Stop navigation when (1) all sites are visited, (2) user defined navigation time has expired, or (3) user defined disk space limit exceeded.

6. At this level, there are N blocks retrieved from the www sites. Run the natural language processing (NLP) technique hereof to rank the paragraphs for best context match.

7. Display paragraphs that score above the threshold in the order starting from the best candidate (to contain the answer to the prime question) to the worst.

The details of the steps 1 and 4 above are exemplified as follows:

Seeds Automatically submitted to search engines:

“Where is the longest river in Zambia, Africa?”

“longest river in Zambia Africa”

+place+longest+river+Zambia+Africa

+location+longest+river+Zambia+Africa

+longest+river+Zambia+Africa

+longest+river+Zambia

+longest+river+Africa

+river+Zambia+Africa

+longest+Zambia+Africa

The combination of two words is not employed, it being assumed that the amount of URLS using two-word-combination seeds will be too high and the top level links (first 20) acquired from the major search engines will not be accurate due to the unfair (or impossible) indexing.

In this example, the search seed +Zambia+Africa will bring URLs with very little chance of encountering the context. Among all combinations, +river+Zambia would be useful, however, all search engines will list the links of this two-word string using the three-word search string +river+Zambia+Africa if Africa was not found.

At each level, in the example for this embodiment, all the links are followed (no repeats) by selecting the best route via PWC threshold. The only exception is at the top level. If there are any links at the top level, the navigation will temporarily stop by the assumption that the entire question has been found in a URL that will probably contain its answer. The user can choose to continue navigation.

FIG. 13 illustrates an embodiment of the overall navigation process, and FIG. 12 can be referred to for the loop logic. In FIG. 13 the block 1310 represents determination of keyword seeds, and the bocks 1315 and 1395 represent represent checking of timeout and spaceout constraints. The blocks 1320 and 1370 respectfully represent first and second navigation stages, and block 1375 represents analysis of texts, etc. as described hereinabove.

1. A method for analyzing a number of candidate answer texts to determine their respective relevance to a query text, comprising the steps of:
producing, for respective candidate answer texts being analyzed, a word occurrence score that includes a measure of query text words that occur in the candidate answer text;
producing, for respective candidate answer texts being analyzed, a word sequence score that includes a measure of query text word sequences that occur in the candidate answer text; and
determining, for respective candidate answer texts being analyzed, a composite relevance score as a function of the respective word occurrence score and the respective word sequence score.

2. The method as defined by claim 1, further comprising the step of arranging said candidate answer texts in accordance with their composite relevance scores.

3. The method as defined by claim 1, wherein said step of producing, for respective candidate texts being analyzed, a word occurrence score includes normalization of the word occurrence score in accordance with the total number of words in the query text.

4. The method as defined by claim 1, wherein said query text includes a prime query portion and an explanation portion, and wherein said word occurrence score comprises a weighted sum of prime query portion words that occur in the text and explanation portion words that occur in the text, divided by a weighted sum of the total words in the prime query portion and the total words in the explanation portion.

5. The method as defined by claim 1, wherein said query text includes a prime query portion and an explanation portion, and further comprising the step of producing, for said respective answer texts being analyzed, a prime word occurrence score that includes a measure of the number of prime query portion words that occur in the candidate answer text divided by the number of words in the prime query portion; and wherein said composite relevance score, for respective candidate answer texts, is also a function of said prime word occurrence score.

6. The method as defined by claim 1, further comprising the steps of: determining the presence at least one of corresponding sequence of a plurality of words in the query text and the respective candidate answer text being analyzed; producing, for the respective candidate answer text being analyzed, a length index score that depends on the respective ratio of minimum to maximum sequence length as between the candidate answer text being analyzed and the query text; and wherein said composite relevance score, for respective candidate answer texts, is also a function of said length index score.

7. The method as defined by claim 4, further comprising the steps of: determining the presence at least one of corresponding sequence of a plurality of words in the query text and the respective candidate answer text being analyzed; producing, for the respective candidate answer text being analyzed, a length index score that depends on the respective ratio of minimum to maximum sequence length as between the candidate answer text being analyzed and the query text; and wherein said composite relevance score, for respective candidate answer texts, is also a function of said length index score.

8. The method as defined by claim 1, further comprising the steps of: determining the presence at least one of corresponding sequence of a plurality of words in the query text and the respective candidate answer text being analyzed; producing, for the respective candidate answer text being analyzed, a length index that depends on the respective ratio of minimum to maximum sequence length as between the candidate answer text being analyzed and the query text; producing, for the respective candidate answer text being analyzed, an order match index that depends on a summation, over all the corresponding sequences, of the ratio of minimum to maximum distance between words of a sequence; and producing a length and order match score from said length index and said order match index; and wherein said composite relevance score, for respective candidate answer texts, is also a function of said length and order match score.

9. The method as defined by claim 4, further comprising the steps of: determining the presence at least one of corresponding sequence of a plurality of words in the query text and the respective candidate answer text being analyzed; producing, for the respective candidate answer text being analyzed, a length index that depends on the respective ratio of minimum to maximum sequence length as between the candidate answer text being analyzed and the query text; producing, for the respective candidate answer text being analyzed, an order match index that depends on a summation, over all the corresponding sequences, of the ratio of minimum to maximum distance between words of a sequence; and producing a length and order match score from said length index and said order match index; and wherein said composite relevance score, for respective candidate answer texts, is also a function of said length and order match score.

10. The method as defined by claim 8, wherein said step of producing a length and order match score from said length index and said order match index comprises producing a product of said length index and said order match index.

11. The method as defined by claim 1, wherein the components of said composite relevance score are non-linearly processed.

12. The method as defined by claim 4, wherein the components of said composite relevance score are non-linearly processed.

13. The method as defined by claim 10, wherein the components of said composite relevance score are non-linearly processed.

14. The method as defined by claim 1, further comprising the step of outputting at least some of said candidate answer texts having the highest composite relevance scores.

15. The method as defined by claim 2, further comprising the step of outputting at least some of said candidate answer texts having the highest composite relevance scores.

16. The method as defined by claim 4, further comprising the step of outputting at least some of said candidate answer texts having the highest composite relevance scores

17. A method for analyzing a number of candidate answer texts to determine their respective relevance to a query text, comprising the steps of:
producing, for respective candidate answer texts being analyzed, a respective pluralities of component scores that result from respective comparisons with said query text, said comparisons including a measure of word occurrences, word group occurrences, and word sequences occurrences;
determining, for respective candidate answer texts being analyzed, a composite relevance score as a function of said component scores; and
outputting at least some of said candidate answer texts having the highest composite relevance scores.

18. The method as defined by claim 17, wherein said composite relevance score is obtained as a weighted sum of non-linear functions of said component scores.

19. The method as defined by claim 17, wherein said query text includes a prime query portion and an explanation portion, and wherein at least one of said component scores result from comparison of respective candidate answer texts with the entire query text, and wherein at least one of the said component scores result from comparison of respective candidate answer texts with only the query portion.

20. The method as defined by claim 18, wherein said query text includes a prime query portion and an explanation portion, and wherein at least one of said component scores result from comparison of respective candidate answer texts with the entire query text, and wherein at least one of the said component scores result from comparison of respective candidate answer texts with only the query portion.

21. An answer retrieval method, comprising the steps of:
producing a query text;
implementing a search of knowledge sources to obtain a number of candidate answer texts, and determining their respective relevance to the query text, as follows:
producing, for respective candidate answer texts being analyzed, a respective pluralities of component scores that result from respective comparisons with said query text, said comparisons including a measure of word occurrences, word group occurrences, and word sequences occurrences;
determining, for respective candidate answer texts being analyzed, a composite relevance score as a function of said component scores; and
outputting at least some of said candidate answer texts having the highest composite relevance scores.

22. The method as defined by claim 21, further comprising the steps of implementing a second search of knowledge sources to obtain different candidate answer texts, and determining the respective relevance of said different candidate answer texts to said query text.

23. The method as defined by claim 21, further comprising filtering said query and said candidate answer texts before said determinations or respective relevance.

24. The method as defined by claim 22, further comprising filtering said query and said candidate answer texts before said determinations or respective relevance.

25. The method as defined by claim 21, wherein said composite relevance score is obtained as a weighted sum of non-linear functions of said component scores.

26. The method as defined by claim 21, wherein said query text includes a prime query portion and an explanation portion, and wherein at least one of said component scores result from comparison of respective candidate answer texts with the entire query text, and wherein at least one of the said component scores result from comparison of respective candidate answer texts with only the query portion.
